(19) United States
(12) Patent Application Publication
(10) Pub. No.: US 2025/0001556 A1
(43) Pub. Date: Jan. 2, 2025

(54) MULTIFUNCTIONAL ELECTRIC SUCTION CUP

(71) Applicant: Jianchang Liu, Shangrao (CN)

(72) Inventor: Jianchang Liu, Shangrao (CN)

(21) Appl. No.: 18/357,511

(22) Filed: Jul. 24, 2023

(30) Foreign Application Priority Data
Jun. 27, 2023 (CN) 2023107654231
Jun. 27, 2023 (CN) 2023216450474

(51) Int. Cl. B25B 11/00

(52) U.S. Cl. CPC B25B 11/007

(57) ABSTRACT

Disclosed is a new type of multifunctional electric suction cup, comprising a base, a shell, a bracket, a protective case, a display screen, a charging port, an extension switch interface, and a debugging button, wherein the upper surface of the base is provided with a shell, a bracket, and a protective case that are fixedly connected; the protective case is provided with a switch, and the top of the shell is provided with an external outlet connected to the atmosphere; the upper surface of the base is provided with a single-chip microcomputer, a power assembly, a battery pack, a display screen, a charging port, an extension switch interface, and a debugging button; the bottom of the base is provided with an air intake, and the air inlet of the power assembly is connected to the air intake through a conduit.

### 1. TECHNICAL FIELD

The invention relates to the field of vacuum suction cup tools, in particular to a new type of multifunctional electric suction cup.

### 2. BACKGROUND ART

In the current construction and decoration industry, when it is necessary to move flat materials such as ceramic tiles and door and window glass, it is often carried manually. Before moving, workers must not only wear protective equipment, but also separate the flat materials that are stacked together; these superimposed flat materials are not only adsorbed to each other, it is difficult to separate, and the surface is smooth, and it is easy to slip from the hand if you are not careful, so that the broken product rate increases;

The manual suction cups on the market carry these flat materials by absorbing them, but the manual suction cups are absorbed by manual pressing, which may easily cause insufficient pressing force, fail to hold them well and fall off;

In addition, some electric vacuum suction cups have also appeared on the market, but the electric suction cups in the prior art have the following problems: 1) the suction force cannot be adjusted during work; if the suction force is too large, fragile flat materials such as glass and ceramic tiles will be easily crushed; if the suction force is too small, it will easily cause adsorption instability; 2) it is inaccurate in detecting the working pressure, and cannot provide visual functions for the working pressure and power; 3) after the product encounters water or other liquids, it will bring safety hazards to the internal electrical components of the product after inhalation; 4) there is air leakage during use, which affects the adsorption effect.

### 3. SUMMARY OF THE INVENTION

The technical problem to be solved by the invention is to overcome the defects of the above technologies and provide a new type of multifunctional electric suction cup.

In order to solve the above technical problems, the invention provides a new type of multifunctional electric suction cup, comprising a base, a shell, a bracket, a protective case, a display screen, a charging port, an extension switch interface, and a debugging button, wherein the upper surface of the base is provided with a shell, a bracket, and a protective case that are fixedly connected; the protective case is provided with a switch, and the top of the shell is provided with an external outlet connected to the atmosphere;
the upper surface of the base is provided with a single-chip microcomputer, a power assembly, a battery pack, a display screen, a charging port, an extension switch interface, and a debugging button; the bottom of the base is provided with an air intake, and the air inlet of the power assembly is connected to the air intake through a conduit; the conduit is provided with a four-way connection, and the four-way connection is provided with a solenoid valve and a pressure sensor; the air outlet of the power assembly is provided with a discharge pipe;
the bottom of the base is provided with a plurality of anti-slip bumps; the lower surface of the base is provided with two annular grooves, and the two annular grooves are respectively provided with a No. 1 sealing ring and a No. 2 sealing ring;
the single-chip microcomputer is electrically connected to the display screen, the debugging button, the power assembly, the battery pack, the solenoid valve, and the pressure sensor respectively.

Further, the base is made of high-strength alloy material.

Further, the protective case is provided with an inner cavity corresponding to the bracket, and the bracket is located in the inner cavity of the protective case; a warning label is attached to the connection between the two ends of the protective case and the base.

Further, the protective case is provided with a switch dustproof plug corresponding to the position of the switch.

Further, the external outlet is arranged correspondingly to the discharge pipe.

Further, the shell is provided with a No. 1 placement opening and a No. 2 placement opening; the charging port and the debugging button are located in the No. 1 placement opening, and the extension switch interface is located in the No. 2 placement opening; the No. 1 placement opening and the No. 2 placement opening are respectively provided with outer covers.

Further, the air inlet conduit of the power assembly is provided with a one-way valve.

Further, the air intake runs through the base.

The advantages of the invention compared with prior art are:
1) through the cooperation of single-chip microcomputer, switch, pressure sensor, debugging button, power assembly, display screen, etc., this device can realize the adjustment, monitoring and display of the suction force in the working state, so as to adjust the suction force in time according to the demand;
2) the display screen can display battery power, adsorption weight and negative pressure value;
3) the base is made of high-strength alloy material, which not only improves the strength, but also reduces the overall weight of the device;
4) the extension switch interface can connect multiple electric suction cups in series and use them at the same time, improving the scope of application;
5) the device is equipped with a double-layer sealing ring, which has better sealing performance and reduces air leakage during use; at the same time, the anti-slip pumps can increase the side adsorption weight.

### 4. BRIEF DESCRIPTION OF ACCOMPANY DRAWINGS

FIG. 1 is a first structural diagram of the new type of multifunctional electric suction cup according to the invention;

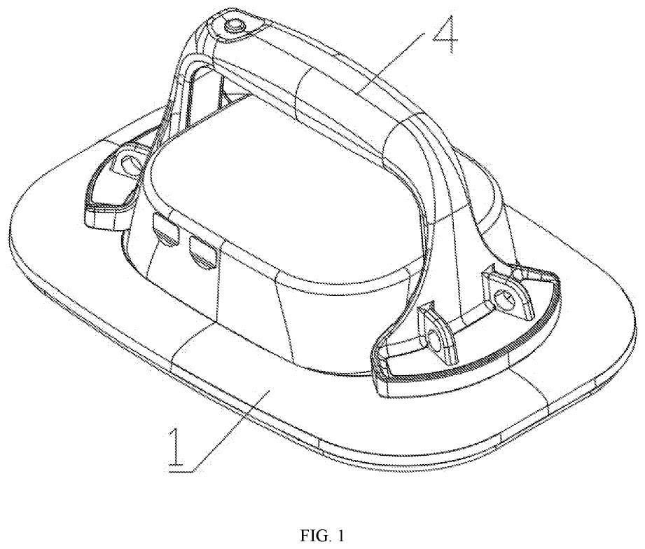

FIG. 2 is a second structural diagram of the new type of multifunctional electric suction cup according to the invention;

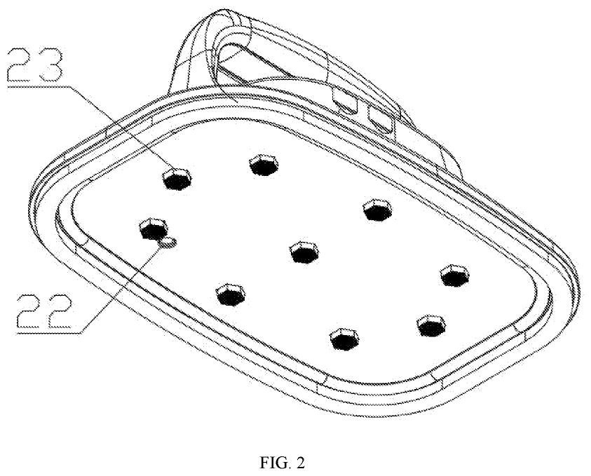

FIG. 3 is a first exploded diagram of the new type of multifunctional electric suction cup according to the invention;

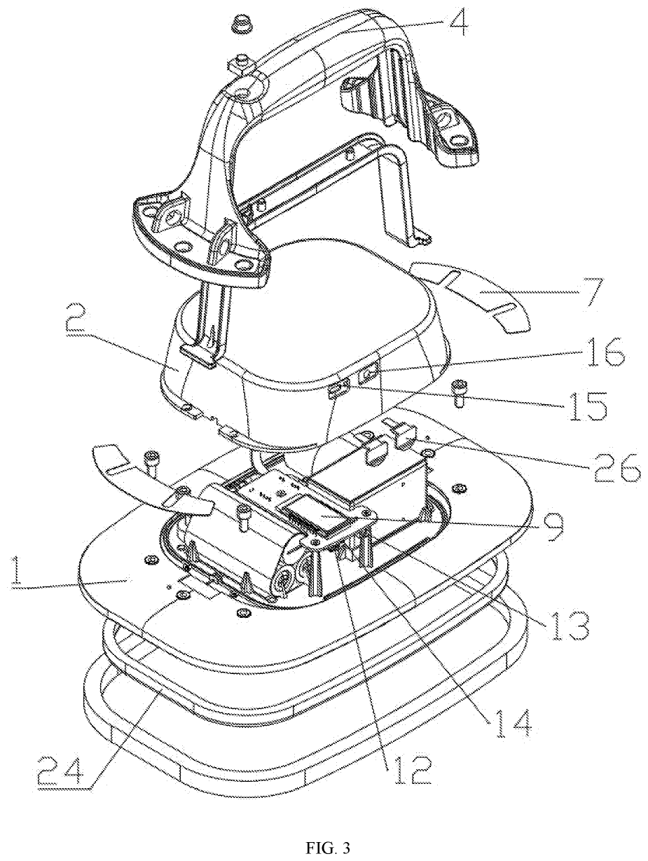

FIG. 4 is a second exploded diagram of the new type of multifunctional electric suction cup according to the invention;

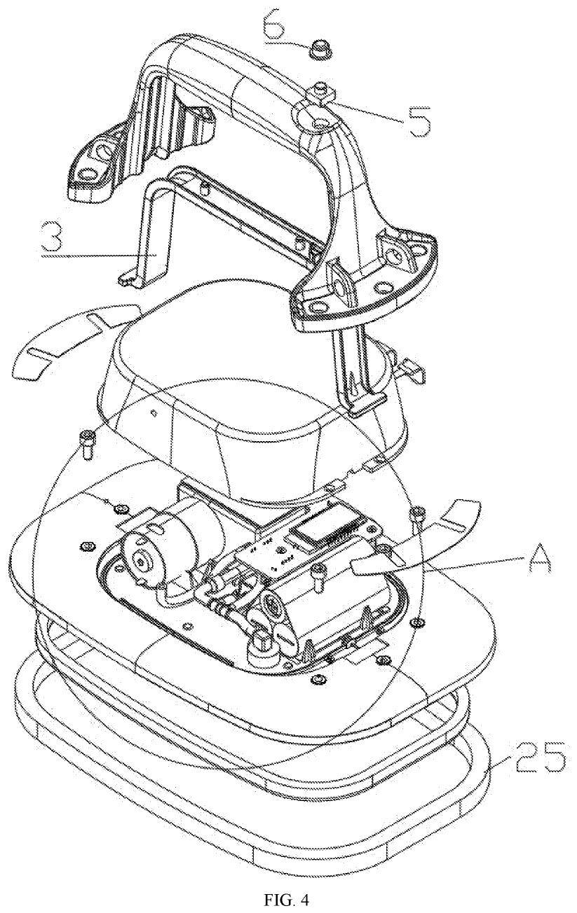

FIG. 5 is an enlarged view of part A in FIG. 4 of the new type of multifunctional electric suction cup according to the invention;

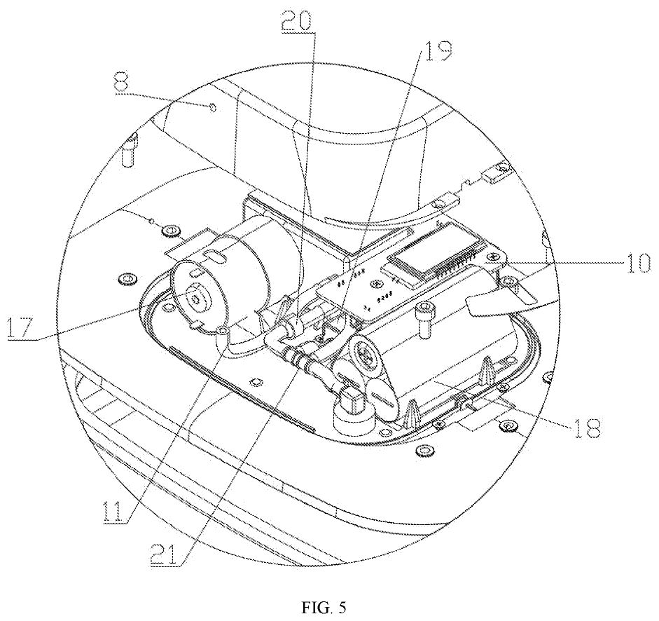

FIG. 6 is a circuit diagram of the new type of multifunctional electric suction cup according to the invention.

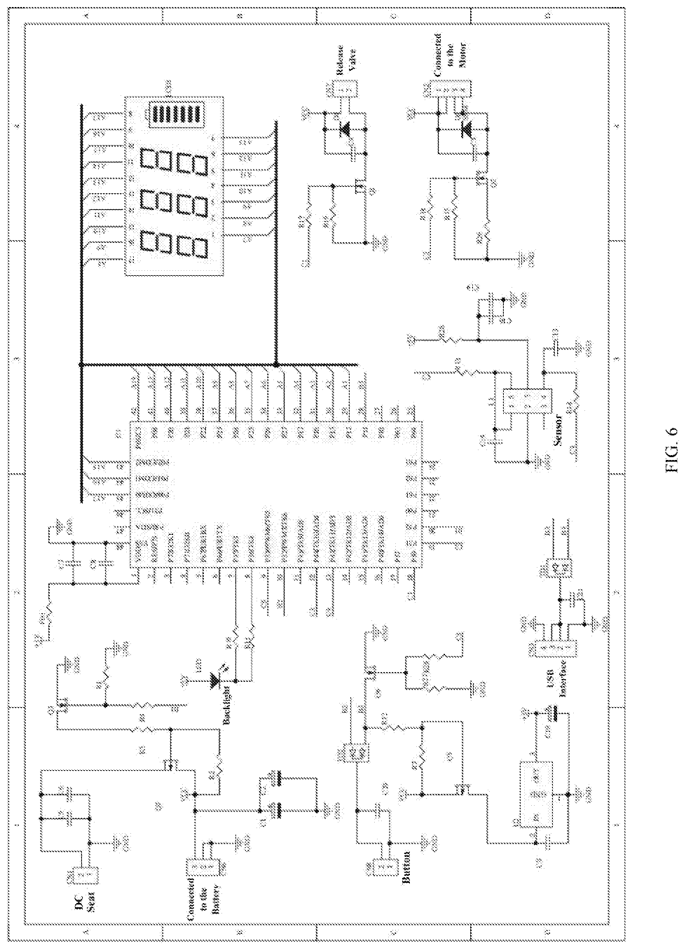

As shown in the figures: 1 refers to the base; 2 refers to the shell; 3 refers to the bracket; 4 refers to the protective case; 5 refers to the switch; 6 refers to the switch dustproof plug; 7 refers to the warning label; 8 refers to the external outlet; 9 refers to the display screen; 10 refers to the single-chip microcomputer; 11 refers to the discharge pipe; 12 refers to the charging port; 13 refers to the extension switch interface; 14 refers to the debugging button; 15 refers to the No. 1 placement opening; 16 refers to the No. 2 placement opening; 17 refers to the power assembly; 18 refers to the battery pack; 19 refers to the solenoid valve; 20 refers to the one-way valve; 21 refers to the four-way connection; 22 refers to the air intake; 23 refers to the anti-slip pumps; 24 refers to the No. 1 sealing ring; 25 refers to the No. 2 sealing ring; 26 refers to the outer cover.

### 5. SPECIFIC EMBODIMENT OF THE INVENTION

The new type of multifunctional electric suction cup according to the invention will be further described in detail hereinafter with reference to the drawings.

With reference to the drawings, new type of multifunctional electric suction cup, comprising a base 1, a shell 2, a bracket 3, a protective case 4, a display screen 9, a charging port 12, an extension switch interface 13, and a debugging button 14, wherein the upper surface of the base 1 is provided with a shell 2, a bracket 3, and a protective case 4 that are fixedly connected; the protective case 4 is provided with a switch 5, and the top of the shell 2 is provided with an external outlet 8 connected to the atmosphere;
the upper surface of the base 1 is provided with a single-chip microcomputer 10, a power assembly 17, a battery pack 18, a display screen 9, a charging port 12, an extension switch interface 13, and a debugging button 14; the bottom of the base 1 is provided with an air intake 22, and the air inlet of the power assembly 17 is connected to the air intake 22 through a conduit; the conduit is provided with a four-way connection 21, and the four-way connection 21 is provided with a solenoid valve 19 and a pressure sensor; the air outlet of the power assembly 17 is provided with a discharge pipe 11;
the bottom of the base 1 is provided with a plurality of anti-slip bumps 23; the lower surface of the base 1 is provided with two annular grooves, and the two annular grooves are respectively provided with a No. 1 sealing ring 24 and a No. 2 sealing ring 25;
the single-chip microcomputer 10 is electrically connected to the display screen 9, the debugging button 14, the power assembly 17, the battery pack 18, the solenoid valve 19, and the pressure sensor respectively.

Preferably, the base 1 is made of high-strength alloy material.

Preferably, the protective case 4 is provided with an inner cavity corresponding to the bracket 3, and the bracket 3 is located in the inner cavity of the protective case 4; a warning label 7 is attached to the connection between the two ends of the protective case 4 and the base 1.

Preferably, the protective case 1 is provided with a switch dustproof plug 6 corresponding to the position of the switch 5.

Preferably, the external outlet 8 is arranged correspondingly to the discharge pipe 11.

Preferably, the shell 2 is provided with a No. 1 placement opening 15 and a No. 2 placement opening 16; the charging port 12 and the debugging button 14 are located in the No. 1 placement opening 15, and the extension switch interface 13 is located in the No. 2 placement opening 16; the No. 1 placement opening 15 and the No. 2 placement opening 16 are respectively provided with outer covers 26.

Preferably, the air inlet conduit of the power assembly 17 is provided with a one-way valve 20.

Preferably, the air intake 22 runs through the base 1.

Preferably, the display screen 9 adopts a liquid crystal display screen, which can display battery power, adsorption weight and negative pressure value; the power assembly 17 comprises a DC 12V high-flow pump body, which improves the negative pressure suction value of the device.

When the invention is implemented and the device is used, the user can control the start and stop of the device through the switch 5, press and hold the switch 5 for 3 seconds, the device will complete the start-up, and click the switch 5 after the start-up, then the power assembly 17 can be started to work; the air between the bottom of the base 1 and the adsorbed object will be extracted, and discharged through the discharge pipe 11 and the external outlet 8, so that the device and the middle part of the adsorbed object will form a negative pressure to complete the adsorption of the object; the pressure sensor can monitor the negative pressure value formed by the power assembly 17, and transmit the monitored value to the single-chip microcomputer 10; the single-chip microcomputer 10 will calculate how much weight and negative pressure value can be lifted according to the algorithm, and display it on the display screen 9; after reaching the pressure value, the extraction will stop;
after the transportation of the object is completed, double-click the switch 5 continuously to start the pressure relief operation; when the pressure at the adsorption point returns to normal pressure, the device will be separated from the adsorbed object;
at the same time, the device is also equipped with self-set negative pressure to cope with the use of different scenarios; the user can press the debugging button 14 for 2 seconds, then the pressure value at 9 on the display screen will flash, and use switch 5 to set the required pressure; after the setting is completed, it will be automatically saved after 3 seconds; the display screen 9 can display in real time the remaining power of the battery pack 18 of the device and the suction value under the working state;
at the same time, when there is water or other liquid on the object to be adsorbed, the water or liquid will be discharged through the external outlet 8 provided on the shell 2, so as to protect the electronic components inside the device and achieve the purpose of prolonging the service life of the device; the bottom of the base 1 is provided with a plurality of anti-slip pumps 23, and the lower surface of the base 1 is provided with two annular grooves; the two annular grooves are provided with a No. 1 sealing ring 24 and a No. 2 sealing ring 25 respectively, which can cope with the adsorption of various products with uneven surfaces, have better air leakage prevention effect, and increase the weight of side adsorption.

The invention and the embodiments thereof are described hereinabove, and this description is not restrictive. What is shown in the drawings is only one of the embodiments of the invention, and the actual structure is not limited thereto. All in all, structural methods and embodiments similar to the technical solution without deviating from the purpose of the invention made by those of ordinary skill in the art without creative design shall all fall within the protection scope of the invention.

1. A multifunctional electric suction cup, comprising a base (1), a shell (2), a bracket (3), a protective case (4), a display screen (9), a charging port (12), an extension switch interface (13), and a debugging button (14), wherein the upper surface of the base (1) is provided with a shell (2), a bracket (3), and a protective case (4) that are fixedly connected; the protective case (4) is provided with a switch (5), and the top of the shell (2) is provided with an external outlet (8) connected to the atmosphere;
the upper surface of the base (1) is provided with a single-chip microcomputer (10), a power assembly (17), a battery pack (18), a display screen (9), a charging port (12), an extension switch interface (13), and a debugging button (14); the bottom of the base (1) is provided with an air intake (22), and the air inlet of the power assembly (17) is connected to the air intake (22) through a conduit; the conduit is provided with a four-way connection (21), and the four-way connection (21) is provided with a solenoid valve (19) and a pressure sensor; the air outlet of the power assembly (17) is provided with a discharge pipe (11);
the bottom of the base (1) is provided with a plurality of anti-slip bumps (23); the lower surface of the base (1) is provided with two annular grooves, and the two annular grooves are respectively provided with a No. 1 sealing ring (24) and a No. 2 sealing ring (25);
the single-chip microcomputer (10) is electrically connected to the display screen (9), the debugging button (14), the power assembly (17), the battery pack (18), the solenoid valve (19), and the pressure sensor respectively.

2. The multifunctional electric suction cup of claim 1, wherein the base (1) is made of high-strength alloy material.

3. The multifunctional electric suction cup of claim 1, wherein the protective case (4) is provided with an inner cavity corresponding to the bracket (3), and the bracket (3) is located in the inner cavity of the protective case (4); a warning label (7) is attached to the connection between the two ends of the protective case (4) and the base (1).

4. The multifunctional electric suction cup of claim 1, wherein the protective case (1) is provided with a switch dustproof plug (6) corresponding to the position of the switch (5).

5. The multifunctional electric suction cup of claim 1, wherein the external outlet (8) is arranged correspondingly to the discharge pipe (11).

6. The multifunctional electric suction cup of claim 1, wherein the shell (2) is provided with a No. 1 placement opening (15) and a No. 2 placement opening (16); the charging port (12) and the debugging button (14) are located in the No. 1 placement opening (15), and the extension switch interface (13) is located in the No. 2 placement opening (16); the No. 1 placement opening (15) and the No. 2 placement opening (16) are respectively provided with outer covers (26).

7. The multifunctional electric suction cup of claim 1, wherein the air inlet conduit of the power assembly (17) is provided with a one-way valve (20).

8. The multifunctional electric suction cup of claim 1, wherein the air intake (22) runs through the base (1).
